(19) United States
(12) Patent Application Publication
(10) Pub. No.: US 2006/0007318 A1
(43) Pub. Date: Jan. 12, 2006

(54) Monitoring system center apparatus, monitoring-system-center program, and recording medium having recorded monitoring-system-center program

(75) Inventors: Kenji Kanayama, Nagakakyo-shi (JP); Tishihiro Suzuki, Kyoto-shi (JP); Makoto Tochihara, Kyoto-shi (JP)

Correspondence Address: FOLEY AND LARDNER LLP;SUITE 500, 3000 K STREET NW, WASHINGTON, DC, 20007, US

(73) Assignee: Omron Corporation

(21) Appl. No.: 10/887,332

(22) Filed: Jul. 9, 2004

(51) Int. Cl. H04N 5/232; H04N 7/18; H04N 9/47

(52) U.S. Cl. 348/211.3; 348/143; 382/190

(57) ABSTRACT

An image captured by a monitoring camera is stored in an image database in a monitoring system center apparatus, and is subsequently transmitted as an entire image to a cellular phone. When a user checks the image displayed on the cellular phone and determines that there is an object that the user desires to display in enlarged form, the user accesses and instructs a WEB page provided by the center apparatus to display an enlarged display menu. When an object to be displayed in enlarged form is selected by the user, image recognition processing is performed by an image recognizing unit in the center apparatus. A partial image including the object to be displayed in enlarged form is extracted, and the partial image is transmitted to the cellular phone.

### BACKGROUND OF THE INVENTION

1. Field of the Invention

The present invention relates to a monitoring system center apparatus used in a monitoring system capable of transmitting images captured by a monitoring camera to a portable terminal via a communication network.

2. Description of the Related Art

In recent years, the display performance of cellular phones has been enhanced. For example, an image, such as a photograph, can be displayed on a display screen of a cellular phone. Accordingly, a mode of utilization is popular in which an image captured by a cellular phone having, for example, a CCD (Charge Coupled Device) camera or a CMOS camera built therein is transmitted to a different cellular phone in a form attached to mail, and the cellular phone as the receiving side displays the received photo image on its display screen.

In the meantime, in companies, shops, houses, and the like, monitoring systems have been put into practical use in which any indoor or outdoor abnormality is monitored by using a monitoring camera having an image sensor. Such monitoring systems include a system having monitoring cameras installed in a plurality of places and a monitoring server for performing overall control of these monitoring cameras. In this type of monitoring system, image information captured by each monitoring camera is transmitted to the monitoring server via a communication network, and occurrence of an abnormal event is determined by the monitoring server. A system is also known in which this monitoring server is connected to a center control server installed in, for example, a security company via a wider-area communication network. In the case of such a system, monitoring circumstances by the monitoring cameras can be grasped in the security company based on information transmitted from each monitoring server.

In this type of monitoring system, a mode of utilization has been proposed in which an image captured by the monitoring camera is transferred to a cellular phone and this image is displayed on the display screen of the cellular phone. When, for example, the user wishes to check the state of a room in his or her absence, the monitor image can be checked by the cellular phone by requesting transfer of the image captured by the monitoring camera installed in the room to the cellular phone.

A description will now be given of the manner of transmission and reception of the monitor image in the above-described monitoring system, with specific reference to FIG. 11. A monitoring camera captures an image as denoted by reference numeral P11. When this captured image is transmitted to a cellular phone 51, firstly, image data in the area indicated by the broken line frame F11 in FIG. 11 is extracted in conformity to the aspect ratio of a display screen 52 in the cellular phone 51. After this image data is transformed so as to have pixels of a number same as the number of pixels of the display screen 52 in the cellular phone 51, the transformed image data is transmitted to the cellular phone 51 via a communication line.

In general, a camera built into a cellular phone is designed to capture an image of a human face or the like. Accordingly, in many cases, image capturing region is rather narrow. On the other hand, a monitoring camera is used to perform image capturing for finding any abnormality in an image capturing region and, therefore, usually covers a rather wide region. In other words, the image of a monitoring object such as a person or an animal often occupies only a small portion of the area of the whole image captured by the monitoring camera.

The display screen 52 in the cellular phone 51 has a relatively small screen size, as described above, e.g., 2 to 3 inches in diagonal. The number of pixels is about twenty thousand to eighty thousand pixels, which provides only a low resolution. Therefore, as shown in FIG. 11, when the image data in the broken line frame F11 in the monitor image is displayed on the display screen 52 of the cellular phone 51, the image of a person, an animal or the like as the object to be monitored is displayed in a very small size, failing to provide detailed information.

### SUMMARY OF THE INVENTION

The present invention has been made to solve the above-described problems.

An object of the invention is to provide a monitoring system center apparatus capable of displaying a detailed image of a desired object even on a small display screen in a portable terminal in a monitoring system which transmits an image captured by a monitoring camera to the portable terminal via a communication network.

In order to solve the above-described problem, the invention provides a monitoring system center apparatus communicable with a monitoring camera and a portable terminal via a communication network, the apparatus having: image data recording means for storing captured image data received from the monitoring camera; partial image extracting means for extracting image data of a partial region designated by the portable terminal from the captured image data recorded in the image data recording means; image transformation means for generating transmission image data by changing the number of pixels of the captured image data recorded in the image data recording means so that the captured image data recorded in the image data recording means is changed to data suitable for a display means in the portable terminal, thereby generating the transmission image data based on the partial image data extracted by the partial image extracting means; and transmission means for transmitting the transmission image data generated by the image transformation means to the portable terminal.

The monitoring system center apparatus functions as a center apparatus in a monitoring system to which a monitoring camera and a portable terminal are connected via a communication network. In many cases, monitoring cameras capture images with a number of pixels (for example, about 350 thousand to 110 thousand pixels) large enough to ensure a certain degree of high definition. At first, image data captured by the monitoring camera is stored as the original data in an image data recording means. Normally, an image transformation means changes the number of pixels so that this captured image data is changed to be suitable for the display means of a portable terminal, while maintaining the image capturing screen range as it is (in other words, without narrowing the screen range), and the image data thus transformed for transmission is transmitted to the portable terminal. In general, the number of pixels which can be displayed by the display means of the portable terminal is rather small. Accordingly, the pixel number is reduced as a result of the transformation described above. In this case, the substantially entire captured image is displayed by the portable terminal. However, due to the reduction in the number of pixels, fine configuration or the like information in the captured image cannot be clearly recognized, compared with the original image data captured by the monitoring camera.

When a user of the portable terminal determines that an object to be observed in detail is present in the displayed image, the monitoring system center apparatus is requested to re-transmit a partial region image including the object. In this case, in the monitoring system center apparatus, a partial image extracting means performs processing of extracting the image data of the partial region designated by the portable terminal out from the original captured image data recorded in the image data recording means, without changing the number of pixels. The partial image data thus extracted is transmitted to the portable terminal. In the portable terminal, the object to be observed in detail by the user can be displayed clearly by displaying this partial image.

The described arrangement permits the user to observe first the entirety of an image-capturing and monitoring range through an image which is presented by a small number of pixels and which is captured by the monitoring camera. If there is an object to be observed in more detail in the captured image, it can be displayed in enlarged scale. The enlarged image becomes unclear with detailed information missing if the image is enlarged by increasing the number of pixels simply by performing interpolation or the like technique on the partial region, or performing the enlargement with the pixel number unchanged. It is to be noted that, according to the invention, in displaying an enlarged image, the partial region of interest is extracted from the original high-definition image data recorded in the image data recording means of the monitoring system center apparatus, and the extracted image data is transmitted to the portable terminal. Thus, an enlarged image including detailed information contained in the original captured image data can be displayed by the portable terminal.

In the monitoring system center apparatus of the invention of the above construction, the partial image extracting means may be configured to employ image-recognition processing for the purpose of extraction of the object designated by the portable terminal out from the captured image data, thereby extracting image data of the partial region including the object.

In the above-described configuration, the partial image extracting means can extract the designated object out from the captured image data. Therefore, the user of the portable terminal can obtain a partial image including the object simply by designating the object of which the user desires to obtain a detailed image, for example, only by designating a person, an animal type, or an automobile. In other words, even if the user of the portable terminal desires to look into a particular object in enlarged scale, the user can obtain a desired enlarged image by a very simple operation of specifying the object which is to be displayed in enlarged scale.

In addition, in the monitoring system center apparatus of the invention of the above construction, the transmission means may be configured to transmit the transmission image data to the portable terminal in a form attached to an electronic mail.

With this configuration, the transmission image data is transmitted to the portable terminal as an electronic-mail attachment file. Portable terminals usually have a function of reporting reception of electronic mail. As the monitor image is transmitted in the form of a file attached to electronic mail, the user can immediately recognize reception of a monitor image transmitted. In other words, when the image is transmitted/received in the form of a file attached to the electronic mail, a communication operation may be performed for reception of electronic mail only if the monitor image is transmitted, even if the portable terminal is not always ready for communication. Therefore, the communication cost can be reduced, and the communication load in the portable terminal can be reduced.

Furthermore, the monitoring system center apparatus of the invention of the above construction may further have a WEB function unit for providing, on the Internet, a WEB page for enabling designation of the partial region by the portable terminal.

With this arrangement, if the user determines that the monitor image needs to be displayed in enlarged scale, the user can access the WEB page provided by the WEB function unit in the monitoring system center apparatus by utilizing the WEB browsing function of the portable terminal, and can designate the partial region to be enlarged from this WEB page. It is therefore possible to establish communication with the monitoring system center apparatus for designating the partial region by an ordinary WEB browsing function, without requiring any special program or the like for communication with the monitoring system center apparatus to be installed in the portable terminal.

Furthermore, the monitoring system center apparatus of the invention of the above construction may further have an authentication unit for performing individual authentication on a user of the portable terminal when the portable terminal accesses the WEB page provided by the WEB function unit, and the WEB page provided by the WEB function unit has content for a user identified in authentication by an authentication unit.

According to the above construction, when the WEB page provided by the WEB function unit is accessed for the partial region designation by the portable terminal, the WEB page having the content for the user is displayed only after authentication by the authentication unit. This WEB page is specialized for services and functions which are often used by the user, offering greater convenience for the user.

Furthermore, in the monitoring system center apparatus of the invention of the above construction, the transmission means may be configured to transmit changes concerning image capturing conditions designated by the portable terminal to the monitoring camera, and to transmit to the portable terminal the image data captured under the changed image capturing conditions upon receipt of the captured data from the monitoring camera.

When the user of the portable terminal receives a monitor image from the monitoring system center apparatus and looks into the displayed image, the user may consider that the image capturing conditions are not good. Specifically, there may be a case in which, for example, exposure is insufficient, and the image is dark on the whole, so that the circumstances cannot be recognized clearly. In such a case, the user sends instructions to change the image capturing conditions from the portable terminal. The instructions are transmitted from the monitoring system center apparatus to the monitoring camera. The monitoring camera performs image capturing again under the new image capturing conditions, and the captured image is transmitted from the monitoring system center apparatus to the portable terminal.

As described above, even when image capturing is performed under inferior image capturing conditions, the user is allowed to change the image capturing conditions by giving the instructions from the portable terminal, thereby causing the camera to recapture the object. Thus, an image can always be obtained under satisfactory image capturing conditions, even from a place where brightness changes in accordance with, for example, time. In addition, the change of such an image capturing conditions is controlled by the monitoring system center apparatus, and any special configuration or system need not be provided in the monitoring camera and the portable terminal. Thus, from an overall point of view on the whole system, the cost for implementing a monitoring system having such functions can be reduced.

In the monitoring system center apparatus of the invention of the above construction, the changed image capturing conditions may include at least one of a shutter speed, an aperture, an output screen size, and the number of image capturing frames.

Since the above image capturing conditions can be controlled by the portable terminal, the quality of captured images can be appreciably improved. Therefore, a detailed and clear image of an object in a captured image can be acquired, so that the circumstances can be grasped correctly, and a situation can be conceived in which this captured image is used as photographic evidence.

Furthermore, the monitoring-system-center program of the invention allows each means of the monitoring system center apparatus to be implemented by a computer having a communication function and a data storage function. By loading the program into a computer system, the monitoring system center apparatus can be implemented.

Furthermore, a recording medium of the invention having thereon a recorded monitoring-system-center program allows each means of the monitoring system center apparatus of the invention to be implemented by a computer having a communication function and a data storage function.

By loading the program recorded on the recording medium into the computer system, the monitoring system center apparatus can be implemented.

The above and other objects, features and advantages of the invention will become clear from the following description when the same is read in conjunction with the accompanying drawings.

### BRIEF DESCRIPTION OF THE DRAWINGS

FIG. 1 is a schematic illustration showing the outline of the flow of enlarged display in a monitoring system according to an embodiment of the invention;

FIG. 2 is a block diagram schematically showing the configuration of the monitoring system;

FIG. 3 is a schematic block diagram showing the configuration of a center apparatus provided in the monitoring system;

FIG. 4 is a block diagram schematically showing the configuration of a monitoring camera provided in the monitoring system;

FIG. 5 is a schematic illustration showing the outline of processing of displaying a monitor image in enlarged scale in response to user's instructions;

FIG. 6 is a schematic illustration of the outline of the flow of image-capturing-condition changing processing in the monitoring system;

FIG. 7 is an illustration of an example of an enlarged display menu displayed on a display screen of a cellular phone;

FIG. 8 is an illustration of an example of an image-capturing-condition menu displayed on a display screen of a cellular phone;

FIG. 9 is a flowchart showing the flow of enlarged display processing performed in the monitoring system;

FIG. 10 is a flowchart showing the flow of image-capturing-condition changing processing in the monitoring system; and

FIG. 11 is an illustration of a state in which an image captured by a monitoring camera is displayed as it is on a cellular phone.

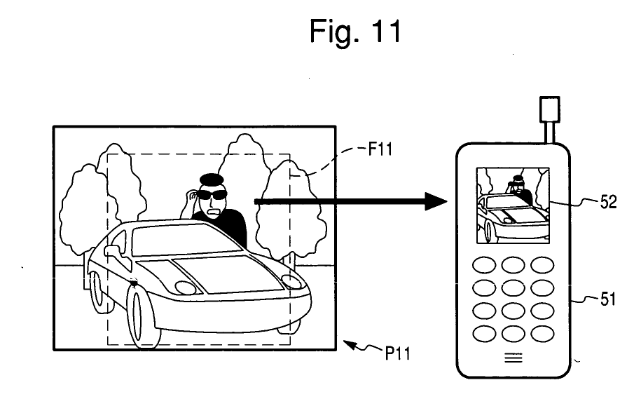

### DESCRIPTION OF THE PREFERRED EMBODIMENT

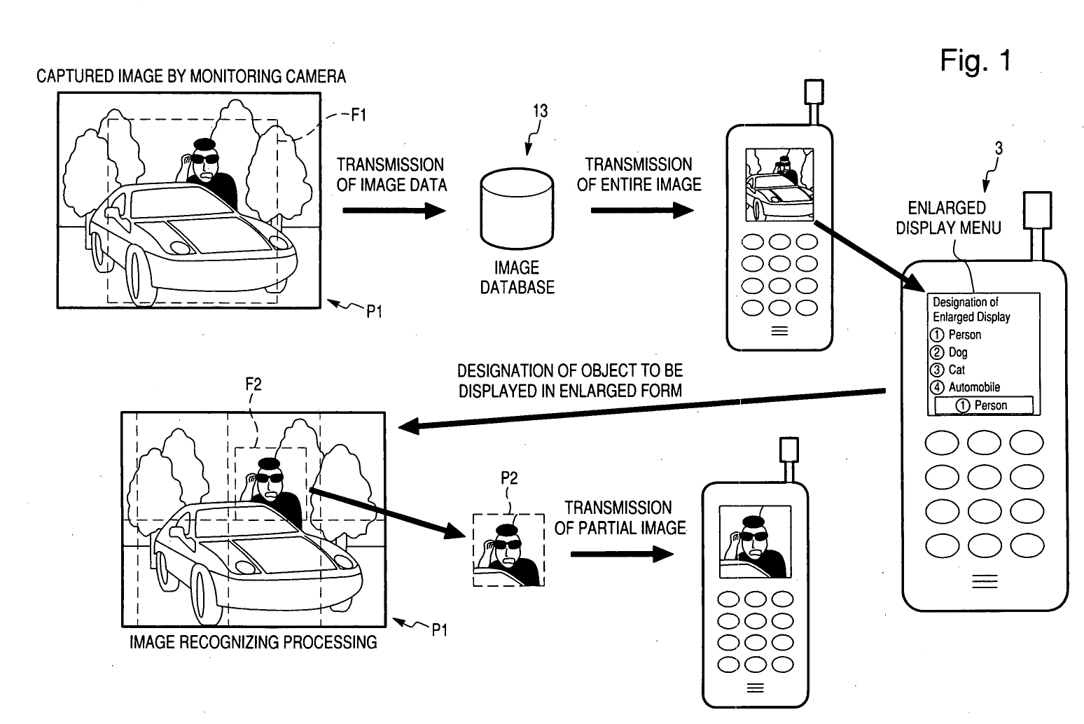

An embodiment of the invention will be described with reference to FIGS. 1 to 10 as follows.

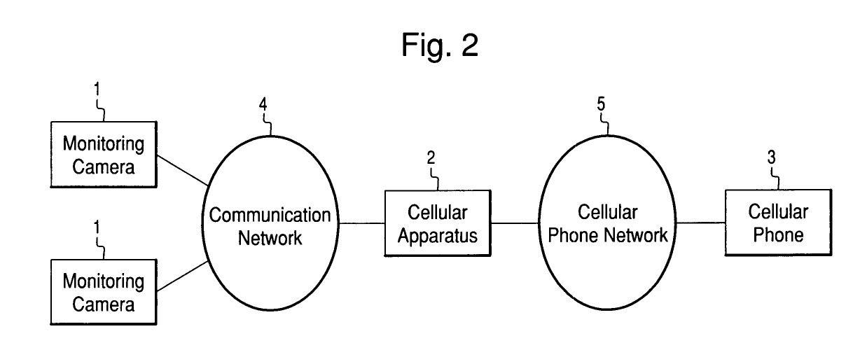

A monitoring system according to this embodiment has a configuration as shown in a block diagram in FIG. 2. Specifically, the monitoring system includes a plurality of monitoring cameras 1, a center apparatus (monitoring system center apparatus) 2, a cellular phone (portable terminal) 3, a communication network 4, and a cellular phone network 5. In FIG. 2, only two monitoring cameras 1 are shown. However, more monitoring cameras 1, may be provided.

The monitoring cameras 1 are connected to the center apparatus 2 via the communication network 4 so that both can communicate with each other. This communication network 4 is realized by a public network, such as a telephone network, the Internet, and a cellular phone packet communication network, dedicated wide-area-line network, or the like. In addition, the communication network 4 may be wireless or wired, or may have a mixed form of wireless and wired communications. For example, a relay unit is provided in the communication network 4, the monitoring cameras 1 are connected to the relay unit by radio, and the relay unit is connected to the center apparatus 2 by wire communication.

In addition, the center apparatus 2 is connected to the cellular phone 3 in a communicable manner via the cellular phone network 5. This cellular phone network 5 is constituted by a network based on the Internet, and a network based on a cellular phone communication link. In other words, a base station on the cellular phone network is connected to the center apparatus 2 via the Internet, and the base station is connected to the cellular phone 3 via the cellular phone communication link.

The monitoring cameras 1 capture images of a region to be monitored by an image sensor. These monitoring cameras 1 are installed in places requiring capturing of monitor images. For example, in houses, generally the monitoring cameras 1 are installed at the positions to monitor the regions, such as an entrance, windows, a garden, and a porch.

In addition, images captured by the monitoring cameras 1 are compressed and temporarily stored, and subsequently transmitted to the center apparatus 2 via the communication network 4. The detailed configuration of each monitoring camera 1 will be described later.

The center apparatus 2 receives each captured image from the monitoring cameras 1, stores the captured image, adequately performs data conversion on the captured image in response to a request from the cellular phone 3, and transmits the converted image to the cellular phone 3. In some cases, in response to the instruction from the cellular phone 3, a command to control image capturing operation is transmitted to the monitoring camera 1. The detailed configuration of the center apparatus 2 will be described later.

The cellular phone 3 is a cellular phone having a mail transmission-reception function, a WEB browsing function, etc., in addition to an ordinary conversation function. The cellular phone 3 includes a communication unit for performing conversation communication and data communication, a display unit for performing various types of display operations, an arithmetic operation unit for performing various types of arithmetic operations, a storage unit for storing data, and an input unit having various types of buttons for inputting, where these component units are not shown.

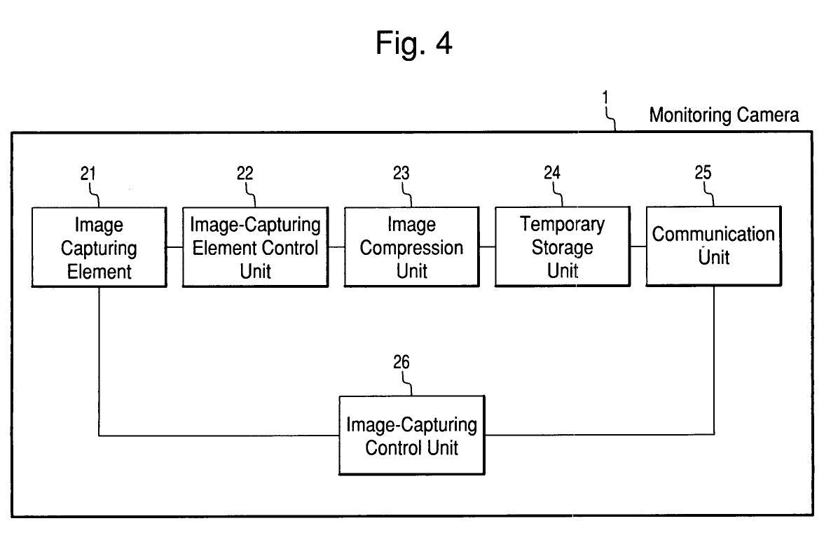

Next, the configuration of the monitoring camera 1 will be described with reference to FIG. 4. As shown in FIG. 4, the monitoring camera 1 includes an image capturing element 21, an image-capturing-element control unit 22, an image compression unit 23, a temporary storage unit 24, a communication unit 25, and an image-capturing control unit 26.

The image capturing element 21 is a block referred to as a so-called “imager” which converts a peripheral image into an electric signal by converting input light into the electric signal. The image capturing element 7 includes a lens, an aperture mechanism, and an image sensor, which are not shown. The lens and the aperture mechanism adjust focusing and lens stopping. In addition, the image sensor is formed by a solid-state image sensing device such as a CCD or CMOS image sensing device, or an image pickup tube.

The image-capturing-element control unit 22 is a block for controlling the image capturing operation in the image capturing element 21 or for processing an image signal captured by the image capturing element 21. This image-capturing-element control unit 21 includes a sample holding unit, an A/D converter, a timing generator, and a synchronous generator, which are not shown.

The sample holding unit temporarily holds image data, as the analog signal, captured by the image sensor in units of samples. The A/D converter converts the image data as the analog signal captured by the image sensor into digital signal. The synchronous generator generates a synchronous clock which causes various types of operations in the monitoring camera 1. Based on the synchronous clock generated by the synchronous generator, the timing generator generates a timing signal determining operational timing in each of the image sensor, the sample holding unit, and the A/D converter. The image sensor, the sample holding unit, and the A/D converter operate based on the timing signal, whereby image capturing through AND conversion can be accurately performed without any error.

The image compression unit 23 is a block for compressing image data output from the image-capturing-element control unit 22. The compression is intended to reduce the data size of the image data, and the compression is performed based on an existing compression algorithm. This compression algorithm may be both irreversible and reversible.

The temporary storage unit 24 is a block for temporarily storing the image data compressed by the image compression unit 23. The stored image data is adequately transmitted from the communication unit 25. In other words, this temporary storage unit 24 functions as a communication buffer.

The communication unit 25 is a block for communicating with the center apparatus 2 via the communication network 4. This communication unit 25 transmits the image data stored in the temporary storage unit 24 to the center apparatus 2 or receives some instruction signals from the center apparatus 2.

The image-capturing control unit 26 is a block for controlling various types of processing in the monitoring camera 1. More specifically, it controls focusing and lens stopping for a lens and stopping mechanism in the image capturing element 21, controls the image capturing start to the timing generator in the image-capturing-element control unit 22, controls the shutter speed, and controls shutter intervals in consecutive image capturing mode. These control operations are performed based on image capturing instruction data received by the communication unit 25. In addition, this image-capturing control unit 26 enables the addition of new camera functions, which will become available in the future, and absorbing the setting of the image capturing environmental conditions to the camera from a camera utilization system.

Regarding the image capturing element 21 and the image-capturing-element control unit 22, various types of dedicated LSIs in which these components are integrated have been commercialized. In these dedicated LSIs, the image capturing specifications, such as exposure control (focusing and shutter speed) and output image size, can be changed by changing parameters in initial setting in a case such as switching-on of power. In the embodiment, the above control operations in the image-capturing control unit 26 are implemented by utilizing the parameter changing function. If the image capturing specifications can be changed not by initial setting parameters of the dedicated LSI but by some command or the like, the above control operations may be performed by commands.

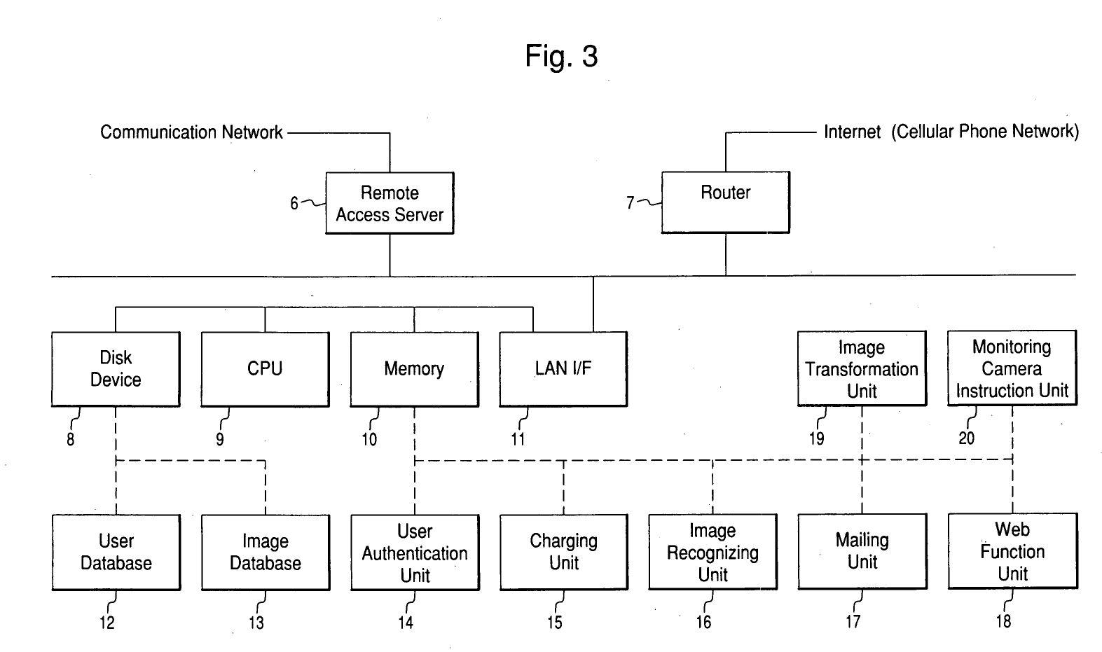

Next, the configuration of the center apparatus 2 will be described with reference to FIG. 3. As shown in FIG. 3, the center apparatus 2 includes a remote access server 6, a router 7, a disk device 8, a CPU 9, a memory 10, and a LAN I/F 11. The disk device 8, the CPU 9, the memory 10, and the LAN I/F 11 are realized by providing them in, for example, one PC (Personal Computer).

The remote access server 6 is a device serving as a communication interface for the communication network 4, and performs processing of communication with the monitoring camera 1. The router 7 is a device serving as a communication interface to the Internet in the cellular phone network 5, and performs processing with communication with the cellular phone 3.

The LAN I/F 11 is a block serving as an interface to LAN in a PC having the disk device 8, the CPU 9, and the memory 10. Here, LAN device LAN to which the remote access server 6, the router 7, and the above PC are connected. The PC performs the communication with the monitoring camera 1 and the cellular phone 3 via this LAN I/F 11. Other computers than the above computer may be connected to this LAN.

The disk device 8 stores various types of data, and is formed by, for example, a recording unit such as a hard disk. This disk device 8 stores a user database 12 and an image database (image data recording means) 13, as shown in FIG. 3.

The user database 12 stores information on users of the monitoring system. The information includes, for example, user names, user addresses, user IDs, passwords, contact mail addresses, a list of monitoring cameras in use, and addresses thereof, the cellular phone numbers and mail addresses, information of objects to be monitored, which are described below, and charging information.

The image database 13 stores data of monitor images transmitted from the monitoring cameras 1. This monitor image data is managed and stored for each user together with information of the monitoring camera 1, which performs image capturing, and information on image capturing time.

On the disk device 8, an OS (Operating System) program for operating the PC, programs for performing processes, which are described below, and various types of data are recorded.

The CPU 9 performs arithmetic operations, and executes a program loaded into the memory 10. The memory 10 functions as a work memory, and is formed by, for example, a DRAM. Various types of programs are loaded into the memory 10 from the disk device 8 and are executed by the CPU 9, whereby the user authentication unit (authentication unit) 14, charging unit 15, image recognizing unit 16 (partial region extracting means), mailing unit (transmission means) 17, WEB function unit 18, image transformation unit (image transformation means) 19, and monitoring camera instruction unit (transmission means) 20 shown in FIG. 3 are realized. In other words, these processing units are realized by programs for allowing a computer to execute each type of processing.

The user authentication unit 14 is a functional block for performing authentication concerning whether a user is an authorized user of the monitoring system by the center apparatus 2 when the user uses the cellular phone 3 to access the center apparatus 2. Specifically, authentication is performed by collating a user ID and password transmitted from a user with user information stored in the user database 12 when the user performs accessing.

The charging unit 15 is a functional block for generating charging information in response to utilization by a user. The charging information generated by the charging unit 15 is stored in the user database 12, and charging the user is periodically performed.

The image recognizing unit 16 is a functional block to recognize and extract the image to be monitored by, for example, the pattern matching, to the image data captured by the monitoring camera 1 and stored in the image database 13. Detailed processing in this image recognizing unit 16 will be described below.

The mailing unit 17 is a functional block in which, when image data captured by the monitoring camera 1 is transmitted by using an automatic function of the monitoring system, and when the user uses the cellular phone 3 to request transmission of images captured by a particular monitoring camera 1, corresponding image data is attached to be transmitted to a mail address of the cellular phone 3. In addition, this mailing unit 17 may have a function of, when some message must be transmitted to a user, sending message mail to a mail address of the cellular phone 3 or a mail address registered as a contact address.

The WEB function unit 18 is a block functioning as a WEB server on the Internet. When transmission of, for example, monitor image data is requested from the cellular phone 3, the user accesses a home page provided by the WEB function unit 18 by using a WEB browser in the cellular phone 3, and, after performing the above authentication, needs to send various types of instructions, such as transmission of the monitor image data, through a page customized in accordance with the user.

The image transformation unit 19 generates transmission image data by changing the number of pixels so that the captured image data recorded in the image database 13, or partial image data including a particular object on which image recognition is performed by the image recognizing unit 16, is transformed into data suitable for a display means in the cellular phone 3.

The monitoring camera instruction unit 20 is used to, when changes in image capturing conditions, which will be described below, are directed by the cellular phone 3, transmit image-capturing command data to a monitoring camera 1, which corresponds to the changed conditions.

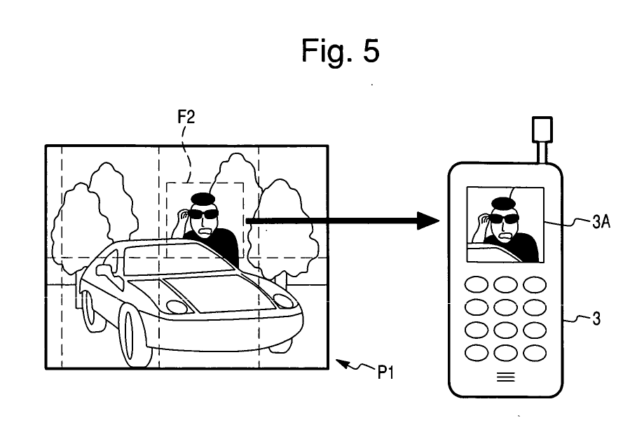

Next, in the monitoring system of this embodiment, processing in which a monitor image is transmitted to the cellular phone 3 will be described below. Firstly, processing that displays monitor image in enlarged form based on a user's instruction will be described. FIG. 5 is a schematic illustration of the outline of the above processing.

Firstly, an image denoted by reference numeral P1 is captured by the monitoring camera 1, and the image data is transmitted to the center apparatus 2 and is stored in the image database 13. When a request for transmission of the monitor image is sent from the cellular phone 3, image data including substantially the entirety of the image P1 is transmitted to the cellular phone 3 and is displayed on a display screen 3A. After that, the user gives an instruction to enlarge a portion having a person, who is to be monitored, and who is included in this image, whereby image data of the region indicated by the broken line frame F2 in FIG. 5 is transmitted to the cellular phone 3 and is displayed on the display screen 3A. A detailed image of the person, who is to be monitored, can also be viewed by the display screen 3A of the cellular phone 3, which is small.

Next, the flow of the enlarged display processing will be described in detail based on the schematic illustration in FIG. 1. Firstly, the image denoted by reference numeral P1 is captured by the monitoring camera 1. The image data is trimmed in the monitoring camera 1 so as to have a size matching the aspect ratio of the display screen of the cellular phone 3, and image data of the broken line frame F1 is transmitted to the center apparatus 2.

In the center apparatus 2, when the image data is received from the monitoring camera 1, this image data is stored in the image database 13 in the disk device 8. In this operation, information on the monitoring camera 1, which performs image capturing, and information of the image capturing time are stored together with the image data. Thereafter, when a request to transmit the monitor image is sent from the cellular phone 3, image data captured by a monitoring camera 1, which is requested by the user is called from the image database 13 by the center apparatus 2. The number of pixels of the image is changed so as to match the resolution of the display screen of the cellular phone 3, and the image data having the changed number of pixels is transmitted as the entire image to the cellular phone 3.

Here, processing of changing the number of pixels will be described. The number of pixels of the image captured in the monitoring camera 1 is considerably larger than that of the display screen of the cellular phone 3. Therefore, when the image indicated by the broken line frame F1 is transmitted to the cellular phone 3, the number of pixels of the image data will be considerably reduced. The processing of changing number of pixels is needs to be performed by, for example, a linear interpolation method or a most predictive method based on immediately adjacent pixels. In other words, the image data transmitted to the cellular phone 3 lacks detailed image information.

When the cellular phone 3 receives the entire image, it is displayed on the display screen. Accordingly, the user of the cellular phone 3 can check the entirety of the monitor image. Here, when the user determines that an object to be displayed in enlarged form is shown in the entire image displayed on the display screen, the user accesses the WEB page provided by the center apparatus 2 by utilizing the WEB browsing function of the cellular phone 3, and, after performing authentication, allows the page of the enlarged display menu in the monitor image transmission service to be displayed. Then, an object to be displayed in enlarged form is selected and transmitted to the center apparatus 2.

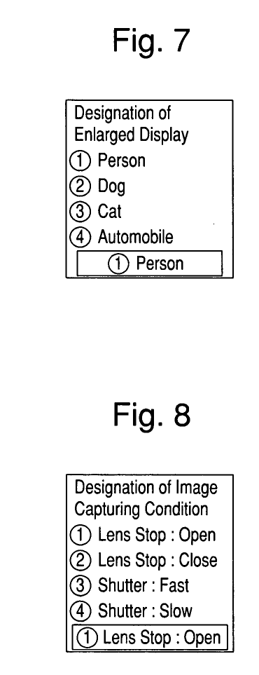

Here, the enlarged display menu will be described. FIG. 7 shows an example of the enlarged display menu when it is displayed on the display screen of the cellular phone 3. In this example, a list of (1) person, (2) dog, (3) cat, and (4) automobile is shown as objects to be enlarged. As these objects to be enlarged, those that can be identified from the image by pattern matching or the like in the image recognizing unit 16 in the center apparatus 2 are shown. The pattern matching is processing of recognizing and extracting an object in the image based on, for example, object shape, and color, or the like. Here, the accuracy of recognition of the object can be increased by registering beforehand, in the center apparatus 2 by the user side, data of images of objects which are subject to the processing.

Regarding choices shown on the enlarged display menu, a default menu set in the center apparatus 2 may be displayed. Alternatively, by registering choices of the objects to be displayed in enlarged form by the user, the registered menu may be displayed.

When an object to be displayed in enlarged form is designated in the cellular phone 3, this information is transmitted to the center apparatus 2, and the object designated by the image recognizing unit 16 is recognized. After the object is recognized, the region F2 including this object is set and image data P2 included in the area is extracted.

The number of pixels of the image data P2 is set so as to be equal to the number of pixels of the display screen of the cellular phone 3. In other words, the image data P2 is changed into the data including all information included in the original image data in the region F2, so that detailed image information is included therein.

The image data P2 is transmitted to the cellular phone 3 as a partial image, and this partial image is displayed on the display screen of the cellular phone 3. Accordingly, the user can check a detailed image of the object to be monitored which is included in the monitor image.

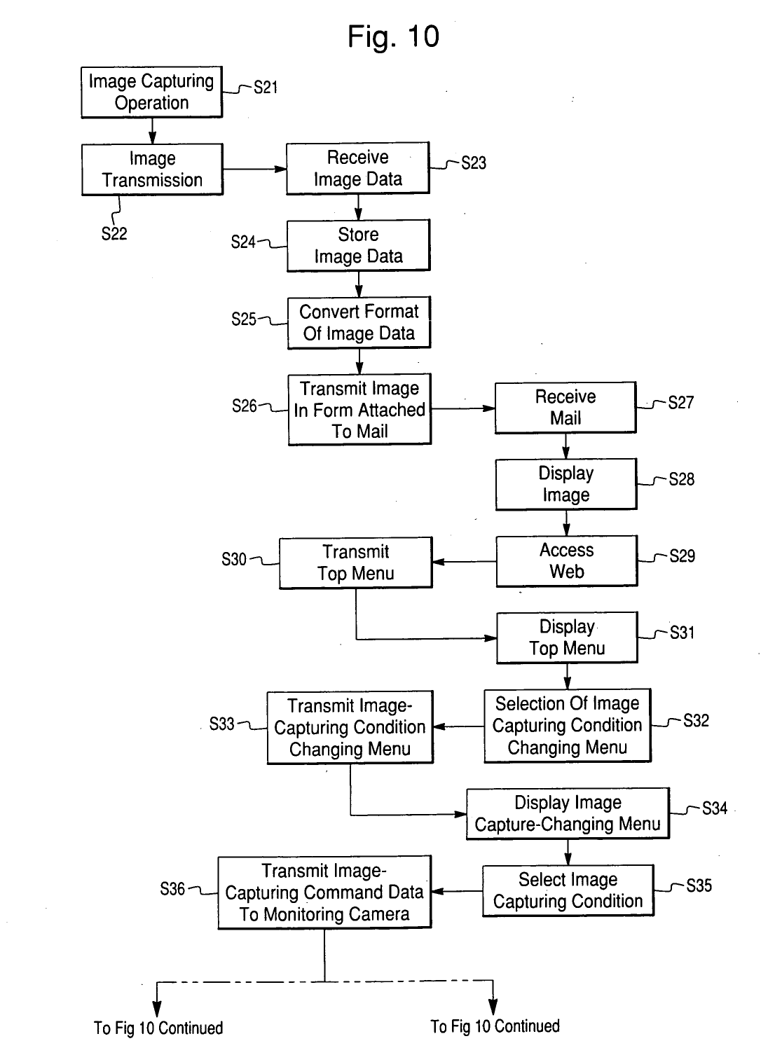

Next, the flow of the enlarged display processing will be described with reference to the flowchart shown in FIG. 9. In FIG. 9, the processing in S1-S2 denotes processing in the monitoring camera 1, the processing in S3-S6, S10, S13, and S16-S17 denotes processing in the center apparatus 2, and the processing in S7-S9, S11-S12, S14-15, and S18 denotes processing in the cellular phone 3.

Firstly, in Step 1 (S1), a monitor image is captured by the monitoring camera 1. This image capturing may be performed periodically or performed when an image capturing command is transmitted from the center apparatus 2 and other devices to the monitoring camera 1 via the communication network 4. When the image capturing is thus performed, the above-described A/D conversion and compression are performed, and the image data is transmitted to the center apparatus 2 (S2).

In the description of the above FIG. 1, the image data transmitted from the monitoring camera 1 to the center apparatus 2 is the image data in the broken line frame F1 shown in FIG. 1. However, the image data is not limited thereto, and the entire captured image may be transmitted as image data to the center apparatus 2. In this case, in processing in S5 described below, the image data is converted to image data of the aspect ratio matching the display screen of the cellular phone 3.

When the center apparatus 2 receives the image data from the monitoring camera 1 (S3), this image data is stored in the image database 13 in the disk device 8 (S4). This image data is converted into the format suitable for transmission to the cellular phone 3 (S5). In this processing, the above-described trimming, the processing of changing the number of pixels, the conversion of the data format, etc., are performed. Then, this image data is transmitted in a form attached to mail to the mail address of the cellular phone 3 of the user.

Regarding timing with which the image data is transmitted from the center apparatus 2 to the cellular phone 3, when a request to transmit image data is sent from the cellular phone 3, the transmission may be performed or may be periodically performed. The mode of transmission may also be set by the user.

When the cellular phone 3 receives the mail with the image data attached thereto (S7), opening this image data is directed by the user, whereby the transmitted image is displayed on the display screen (S8). When the user views the displayed image and determines that an object to be displayed in enlarged form is shown in the image, the user accesses the WEB page provided by the WEB function unit 18 in the center apparatus 2 by utilizing the WEB browsing mechanism of the cellular phone 3 (S9). When the center apparatus 2 receives an access from the cellular phone 3, the data of the top menu is transmitted (S10), and the top menu is displayed on the display screen of the cellular phone 3 (S11).

If authentication is performed by inputting a user ID and a password when the user uses the cellular phone 3 to access the center apparatus 2 to display a top menu, the top menu, which is to be displayed, may have contents matching the user. In this case, only a menu usable by the user is displayed, so that the convenience of the user is enhanced.

The user selects an enlarged display menu from the displayed top menu (S12), and its contents are transmitted to the center apparatus 2. The center apparatus 2 transmits data of the enlarged display menu (S13), and the enlarged display menu is displayed on the display screen of the cellular phone 3 (S14). This enlarged display menu is shown as the above-described screen display shown in FIG. 7.

The user selects an object to be displayed in enlarged form from the displayed enlarged display menu (S15), and its contents are transmitted to the center apparatus 2. When the user recognizes the object to be displayed in enlarged form, the center apparatus 2 uses the image recognition unit 16 to extract the object to be displayed in enlarged form from the image data stored in the image database 13, which corresponds to the object.

After that, the extracted image data is converted into the format suitable for the transmission to the cellular phone 3 (S17), this image data is attached to the mail, and transmitted toward the mail address of the cellular phone 3 of the applicable user. The cellular phone 3 receives this image data, and displays it on the display screen (S18). By the above processing, the enlarged image including the object which the user wishes to check in detail can be displayed on the display screen of the cellular phone 3.

According to the above processing, the user confirms the image in which the image of the firstly received extensive area is captured, and if the user determines that the object which the user wishes to watch in detail is included, the enlarged image of the object to be displayed in enlarged form can be acquired by instructing the object to be displayed in enlarged form to be a person, a cat or the like. Therefore, the desired enlarged image can be obtained by a simple operation even in an appliance with the limited interface for the input such as the cellular phone.

In the above example, when performing the enlargement, the object to be displayed in enlarged form is designated on the cellular phone 3 side, and image recognition is performed on the center apparatus 2 side to extract an image area including the object to be displayed in enlarged form. However, it is not limited thereto. For example, by displaying division lines to divide the area into a plurality of small areas when displaying the image in which the image of the extensive area to be firstly received in the cellular phone 3 is captured, and designating a small area to be enlarged, a system may be employed, in which the enlarged image of the small area is transmitted from the center apparatus 2. More specifically, a method may be employed, in which a selected state is indicated by performing the highlight display of a specified small area, and the desired small area is designated by moving the area of highlight display by a cursor moving button or the like.

If this method is employed, the image recognizing unit 16 in the center apparatus 2 need not be provided. However, a problem will arise, in that a correctly enlarged image cannot be obtained if, for example, an object to be displayed in enlarged form is present across the boundary of each area.

On the other hand, according to a method for extracting the object to be displayed in enlarged form by image recognition, the image including the object to be displayed in enlarged form can be displayed correctly, and a detailed image of the object to be displayed in enlarged form can be displayed in an optimum state on the display screen of the cellular phone 3. However, in some states of the captured image, the object to be displayed in enlarged form cannot be extracted correctly by image recognition. If image recognition cannot be performed successfully, it is preferable to employ a system to execute a method for designating the small area as described above.

Next, description will be made on a method to control the image capturing condition in the monitoring camera 1 from the cellular phone 3. In the past, remotely-operated control of the monitoring camera includes only, for example, the control to start/stop the image capturing, and the control of the image capturing direction. However, with the level of such controls, countermeasures have been impossible to a case that image capturing cannot be performed in an optimum exposure state when keyboard of the image capturing area by the monitoring camera is changed according to the time zone.

On the other hand, in the monitoring system of the embodiment, the image capturing condition of the monitoring camera 1 can be controlled from the cellular phone 3. The control contents of the image capturing condition of the monitoring camera newly include the controls of the shutter speed, the aperture, the output screen size (the number of pixels), the number of image capturing frames (n frames/seconds) during the continuous image capturing in addition to the conventional controls of the image capturing start/stop, the image capturing direction, and the zoom control.

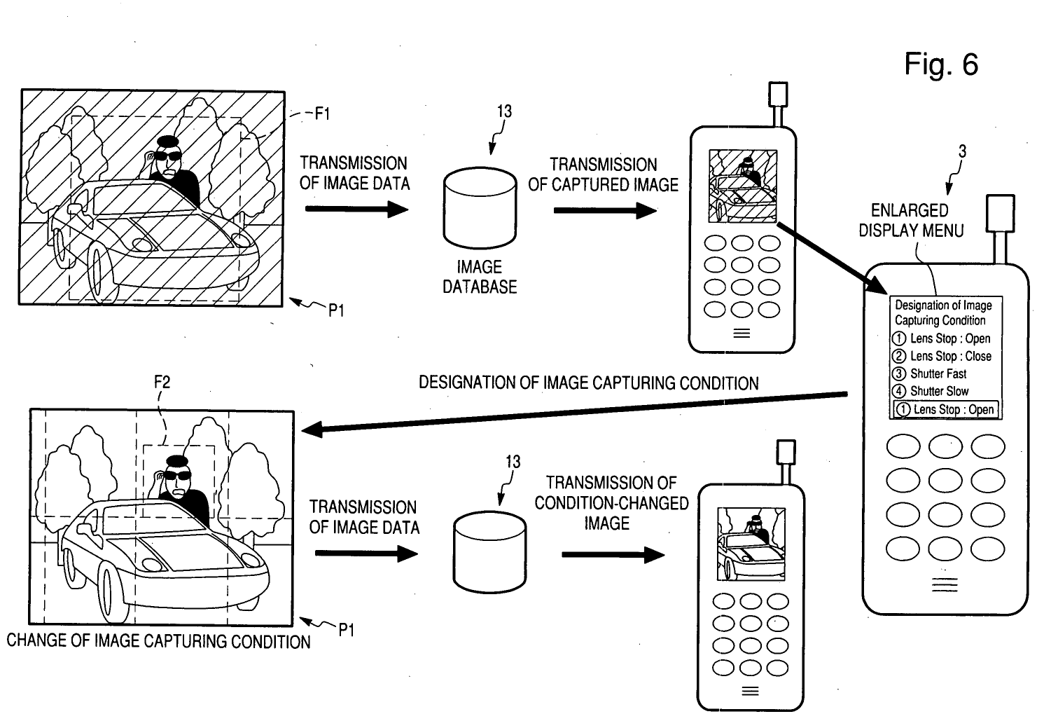

FIG. 6 is a schematic representation to indicate the flow of the processing of controlling the aperture out of the controls of the image capturing condition of the monitoring camera 1. Firstly, the image denoted by reference numeral P1 is captured by the monitoring camera 1. The image data is trimmed in the monitoring camera 1 so as to have a size meeting the aspect ratio of the display screen of the cellular phone 3, and the image data in the broken line frame F1 is transmitted to the center apparatus 2.

In the center apparatus 2, when the image data is received from the monitoring camera 1, this image data is firstly stored in the image database 13 in the disk device 8. In this case, information on the monitoring camera 1 which performed the image capturing and information on the image capturing time are stored together with the image data. Thereafter, when a request to transmit the monitor image is sent from the cellular phone 3, in the center apparatus 2, image data captured by the monitoring camera 1, which is requested by the user, is called from the image database 13, and the number of pixels is changed so as to meet the resolution of the display screen of the cellular phone 3. The image data having the changed number of pixels is transmitted as the captured image to the cellular phone 3.

When the cellular phone 3 receives the captured image, it is displayed on the display screen. Accordingly, the user of the cellular phone 3 can check the entire monitor image. If the user determines that the image capturing conditions of the captured image are not good, and more specifically, exposure is insufficient, the user accesses the WEB page provided by the center apparatus 2 by utilizing the WEB browsing function of the cellular phone 3, and the page of the image capturing condition changing menu in the monitor image transmission service is displayed after authentication. Then, the image capturing condition to be changed is selected and transmitted to the center apparatus 2.

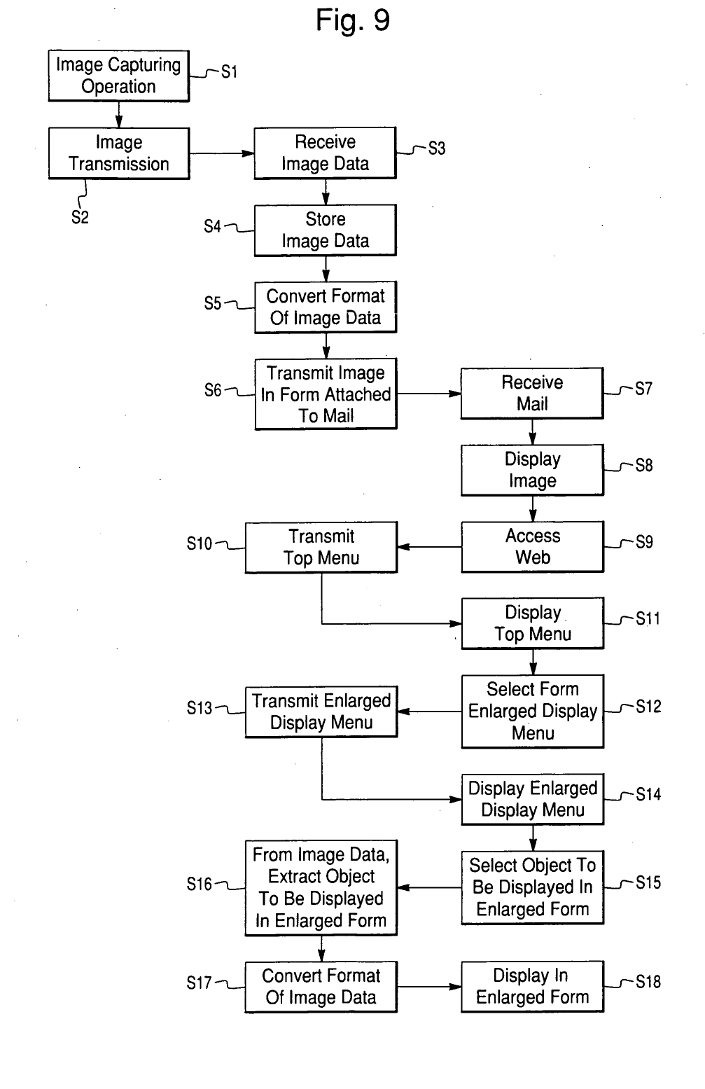

Here, the image capturing condition changing menu will be described. FIG. 8 shows an example of the image capturing condition changing menu when it is displayed on the display screen of the cellular phone 3. In this example, image capturing conditions to be changed include (1) lens stop: open, (2) lens stop: close, (3) shutter: fast and (4) shutter: slow. These image capturing conditions to be changed are image capturing conditions which can be changed in the monitoring camera 1. For example, when information on each monitoring camera 1, in other words, a list of image capturing conditions which can be changed is recorded in the user database 12 of the center apparatus 2, the image capturing condition changing menu can also be generated based on the list.

In the above example, the image capturing conditions on aperture and shutter speed are listed. In addition, the image capturing condition changing menu may change the output screen size (the number of pixels), the number of image capturing frames (n frames/second), zooming, an image capturing direction (vertical and horizontal directions), the start/stop of image capturing, etc.

When the image capturing condition is designated in the cellular phone 3, this information is transmitted to the monitoring camera 1 via the center apparatus 2, and the image capturing condition designated by the image-capturing control unit 26 in the monitoring camera 1 is changed. Image capturing is performed again by using the changed image capturing condition, and this captured image is transmitted to the cellular phone 3 via the center apparatus 2. This enables the user to change the image capturing conditions from the cellular phone 3, so that a clear monitor image can be obtained.

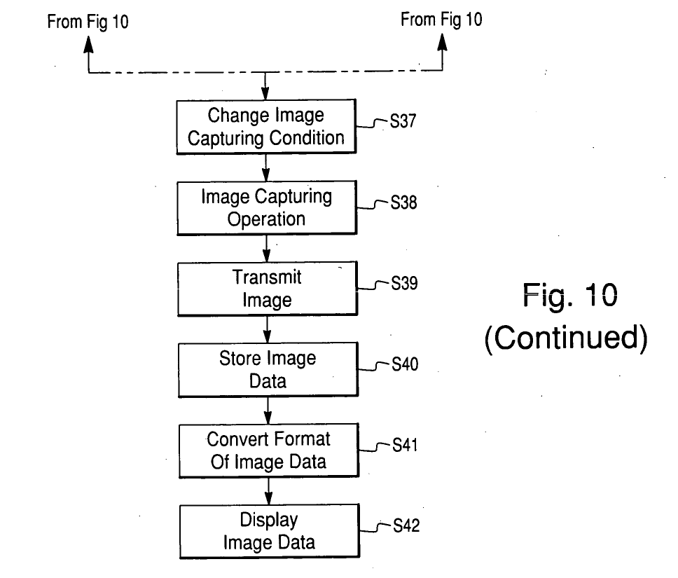

Next, the flow of the above image capturing condition changing processing will be described with reference to the flowchart shown in FIG. 10. In FIG. 10, the processing S21-S22, and S37-S39 denotes processing in the monitoring camera 1, the processing in S23-S26, S30, S33, S36, and S40-S41 denotes processing in the center apparatus 2, and the processing in S27-S29, S31-S32, S34-S35 and S42 denotes processing in the cellular phone 3, respectively.

Firstly, the processing in S21-S27 is similar to the processing in S1-S7 in the flowchart shown in FIG. 9, and a description thereof is omitted here. When the cellular phone 3 receives the mail with the image data attached thereto (S27), opening of this image data is directed by the user, whereby the transmitted image is displayed on the display screen (S28). When the user views the displayed image and determines that the image capturing conditions are not good, the user accesses the WEB page provided by the WEB function unit 18 in the center apparatus 2 by utilizing the WEB browsing function of the cellular phone 3 (S29). When the center apparatus 2 is accessed by the cellular phone 3, data of a top menu is transmitted (S30), and the top menu is displayed on the display screen of the cellular phone 3 (S31).

When the cellular phone 3 accesses the center apparatus 2 to display the top menu, and authentication is performed by inputting a user ID and a password, the top menu to be displayed may have menu contents for the user. Since this case displays only a menu usable for the user, convenience of the user is enhanced.

The user selects the image capturing condition changing menu from the displayed top menu (S32), and its contents are transmitted to the center apparatus 2. The center apparatus 2 transmits the data of the image capturing condition changing menu (S33), and the image capturing condition changing menu is displayed on the display screen of the cellular phone 3 (S34). This image capturing condition changing menu is shown as the screen display in FIG. 8.

The user selects a desired image capturing condition to be changed and change detail from the displayed image capturing condition changing menu (S35), and this detail is transmitted to the center apparatus 2. When the user recognizes the image capturing condition to be changed and the change detail, the center apparatus 2 generates image capturing command data based on the detail, and transmits the command to the monitoring camera 1 (S36).

When the monitoring camera 1 receives the image capturing command data from the center apparatus 2, its content is sent to the image-capturing control unit 26. The image-capturing control unit 26 sets various types of image-capturing-condition parameters in the image capturing element 21 and the image-capturing-element control unit 22 based on the image capturing command data (S37). After the setting of these parameters is completed, the image-capturing control unit 26 directs starting of the image capturing.

When the starting of image capturing is directed, the image capturing operation is performed by the image capturing element 21 and the image-capturing-element control unit 22 based on various types of set parameters (S38). The captured image data is transmitted to the center apparatus 2 via the communication unit 25 (S39).

When the center apparatus 2 receives the image data from the monitoring camera 1, firstly, this image data is stored in the image database 13 in the disk device 8 (S40). Processing of converting this image data into a format suitable for transmission to the cellular phone 3 (S41) is performed. The converted image data is transmitted in form attached to mail to the mail address of the cellular phone 3 of the user. The cellular phone 3 receives and displays the image data on the display screen (S42). In the above processing, a monitor image in which image capturing conditions are improved can be displayed on the display screen of the cellular phone 3.

According to the above processing, if the user checks a firstly received monitor image and determines that image capturing conditions are not good, by directing changing of the image capturing conditions from the cellular phone 3, image capturing can be performed again, with the image capturing conditions of the monitoring camera 1 changed. This enables the user to change the image capturing conditions of the monitoring camera 1 in detail by using a cellular phone that the user usually carriers. Furthermore, the image capturing conditions, such as an aperture, a shutter speed, output screen size, and the number of image capturing frames concerning the monitoring camera 1, can be changed from the cellular phone 3. Thus, the operation of the monitoring camera 1 can be fine-controlled. Therefore, the user can obtain monitor images in desired image state.

In the system that changes the above image capturing conditions, the image data and the image-capturing-condition changing command are transmitted/received through the center apparatus 2. However, the above-described communication can directly be performed between the monitoring camera 1 and the cellular phone 3, not via the center apparatus 2.

If the communication is performed not via the center apparatus 2, the monitoring camera 1 must have an image format conversion function, a function of accessing by the cellular phone 3, a function of communicating with the cellular phone 3 in connection with changing of the image capturing conditions, et al., which causes an increase in cost of the monitoring camera 1. Since the monitoring cameras 1 are preferably installed at as many places as possible, it is preferable to suppress the cost increase of the monitoring cameras 1 per se as much as possible. Therefore, as described above, by using system having the center apparatus 2, the center apparatus 2 can be used in common by the monitoring cameras 1. From an entire system viewpoint, a system which is more efficient compared with the case of performing direct communication between the monitoring camera 1 and the cellular phone 3, can be established.

As described above, the monitoring system center apparatus of the invention is provided with image data recording means for storing captured image data received from the monitoring camera; partial image extracting means for extracting image data of a partial region designated by the portable terminal from the captured image data recorded in the image data recording means; image transformation means for generating transmission image data by changing the number of pixels of the captured image data recorded in the image data recording device so that the captured image data recorded in the image data recording means is changed to data suitable for a display means in the portable terminal, thereby generating the transmission image data based on the partial image data extracted by the partial image extracting means; and transmission means for transmitting the transmission image data generated by the image transformation means to the portable terminal.

The described arrangement permits a user to observe first an image captured by the monitoring camera through the portable terminal. If there is an object to be observed in more detail in the captured image, it can be displayed in enlarged scale. When the image is to be displayed in enlarged scale, the partial region of interest is extracted from the image data recorded in the image data recording means of the monitoring system center apparatus, and the extracted image data is transmitted to the portable terminal. Thus, an enlarged image including detailed information contained in the original captured image data can be displayed by the portable terminal.

In the monitoring system center apparatus of the invention, the partial image extracting means may be configured to employ image-recognition processing for the purpose of extraction of the object designated by the portable terminal out from the captured image data, thereby extracting image data of the partial region including the object.

Therefore, in addition to the advantages of the configuration mentioned above, it is further advantageous in that, even if the user of the portable terminal desires to look into a particular object in enlarged scale, the user can obtain a desired enlarged image by a very simple operation of specifying the object which is to be displayed in enlarged scale.

In addition, in the monitoring system center apparatus of the invention, the transmission means may be configured to transmit the transmission image data to the portable terminal in a form attached to an electronic mail.

With this configuration, it is further advantageous in that, when the image is transmitted/received in the form of a file attached to the electronic mail, a communication operation may be performed for reception of electronic mail only if the monitor image is transmitted, even if the portable terminal is not always ready for communication. Therefore, the communication cost can be reduced, and the communication load in the portable terminal can be reduced.

Furthermore, the monitoring system center apparatus of the invention may further have a WEB function unit for providing, on the Internet, a WEB page for enabling designation of the partial region by the portable terminal.

With this arrangement, it is further advantageous in that communication with the monitoring system center apparatus for designating the partial region is enabled by an ordinary WEB browsing function without requiring any special program or the like for communication with the monitoring system center apparatus to be installed in the portable terminal.

Furthermore, the monitoring system center apparatus of the invention may further have an authentication unit for performing individual authentication on a user of the portable terminal when the portable terminal accesses the WEB page provided by the WEB function unit, and the WEB page provided by the WEB function unit has content for a user identified in authentication by an authentication unit.

According to the above construction, it is further advantageous in that, the WEB page provided by the WEB function unit for the partial region designation by the portable terminal becomes the WEB page that is specialized for services and functions which are often used by the user, offering greater convenience for the user.

Furthermore, in the monitoring system center apparatus of the invention, the transmission means may be configured to transmit changes concerning image capturing conditions designated by the portable terminal to the monitoring camera, and to transmit to the portable terminal the image data captured under the changed image capturing conditions upon receipt of the captured data from the monitoring camera.

With this configuration, even when image capturing is performed under inferior image capturing conditions, the user is allowed to change the image capturing conditions by giving the instructions from the portable terminal, thereby causing the camera to recapture the object. Thus, an image can always obtained under satisfactory image capturing conditions. In addition, the change of such an image capturing conditions is controlled by the monitoring system center apparatus, and any special configuration or system need not be provided in the monitoring camera and the portable terminal. Thus, from an overall point of view on the whole system, the cost for implementing a monitoring system having such functions can be reduced.

In the monitoring system center apparatus of the invention, the changed image capturing conditions may include at least one of a shutter speed, an aperture, an output screen size, and the number of image capturing frames.

Since the above image capturing conditions can be controlled by the portable terminal, the quality of captured images can be appreciably improved.

Furthermore, the monitoring-system-center program of the invention allows each means of the monitoring system center apparatus to be implemented by a computer having a communication function and a data storage function.

Therefore, by loading the program into a computer system, the monitoring system center apparatus can be implemented.

Furthermore, a recording medium of the invention having thereon a recorded monitoring-system-center program allows each means of the monitoring system center apparatus of the invention to be implemented by a computer having a communication function and a data storage function.

By loading the program recorded on the recording medium into the computer system, the monitoring system center apparatus can be implemented.

What is claimed is:

1. A monitoring system center apparatus communicable with a monitoring camera and a portable terminal via a communication network, comprising:
image data recording means for storing captured image data received from the monitoring camera;
partial image extracting means for extracting image data of a partial region designated by the portable terminal from the captured image data recorded in the image data recording means;
image transformation means for generating transmission image data by changing the number of pixels of the captured image data recorded in the image data recording means so that the captured image data recorded in the image data recording means is changed to data suitable for a display means in the portable terminal, thereby generating the transmission image data based on the partial image data extracted by the partial image extracting means; and
transmission means for transmitting the transmission image data generated by the image transformation means to the portable terminal.

2. A monitoring system center apparatus according to claim 1, wherein the partial image extracting means employs image recognition processing to extract an object designated by the portable terminal from the captured image data, thereby extracting image data of a partial region including the object.

3. A monitoring system center apparatus according to claim 1, wherein the transmission means transmits the transmission image data to the portable terminal in the form of an attachment to an electronic mail.

4. A monitoring system center apparatus according to claim 1, further comprising a WEB function unit for providing, on the Internet, a WEB page for enabling partial region designation by the portable terminal.

5. A monitoring system center apparatus according to claim 4, further comprising an authentication unit for performing individual authentication on a user of the portable terminal when the portable terminal accesses the WEB page provided by the WEB function unit,
wherein the WEB page provided by the WEB function unit has content for a user identified in authentication by the authentication unit.

6. A monitoring system center apparatus according to claim 1, wherein the transmission means transmits changed image capturing conditions designated by the portable terminal to the monitoring camera, and transmits to the portable terminal the image data captured under the changed image capturing conditions upon receipt of the captured image data from the monitoring camera.

7. A monitoring system center apparatus according to claim 6, wherein the changed image capturing conditions include at least one of a shutter speed, an aperture, an output screen size, and the number of image capturing frames.

8. A monitoring-system-center program for allowing a computer to implement each means of the monitoring system center apparatus according to claim 1, the computer having a communication function and a data storage function.

9. A recording medium having thereon a recorded monitoring-system-center program allowing a computer to implement each means of the monitoring system center apparatus according to claim 1, the computer having a communication function and a data storage function.

10. A monitoring system center apparatus communicable with a monitoring camera and a portable terminal via a communication network, comprising:
an image data recording device configured to store captured image data received from the monitoring camera;
a partial image extracting device configured to extract image data of a partial region designated by the portable terminal from the captured image data recorded in the image data recording device;
an image transformation device configured to generate transmission image data by changing the number of pixels of the captured image data recorded in the image data recording device so that the captured image data recorded in the image data recording device is changed to data suitable for a display device in the portable terminal, thereby generating the transmission image data based on the partial image data extracted by the partial image extracting device; and
a transmission device configured to transmit the transmission image data generated by the image transformation device to the portable terminal.

11. A monitoring system center apparatus according to claim 10, wherein the partial image extracting device is configured to employ an image recognition processing to extract an object designated by the portable terminal from the captured image data, thereby extracting image data of a partial region including the object.

12. A monitoring system center apparatus according to claim 10, wherein the transmission device is configured to transmit the transmission image data to the portable terminal in the form of an attachment to an electronic mail.

13. A monitoring system center apparatus according to claim 10, further comprising a WEB function unit configured to provide on the Internet, a WEB page for enabling partial region designation by the portable terminal.

14. A monitoring system center apparatus according to claim 13, further comprising an authentication unit configured to perform individual authentication on a user of the portable terminal when the portable terminal accesses the WEB page provided by the WEB function unit,
wherein the WEB page provided by the WEB function unit has content for a user identified in authentication by the authentication unit.

15. A monitoring system center apparatus according to claim 10, wherein the transmission device is configured to transmit changed image capturing conditions designated by the portable terminal to the monitoring camera, and to transmit to the portable terminal the image data captured under the changed image capturing conditions upon receipt of the captured image data from the monitoring camera.

16. A monitoring system center apparatus according to claim 15, wherein the changed image capturing conditions include at least one of a shutter speed, an aperture, an output screen size, and the number of image capturing frames.
